(19) United States
(12) Patent Application Publication
(10) Pub. No.: US 2026/0045041 A1
(43) Pub. Date: Feb. 12, 2026

(54) GENERATING MESHES BY DECODING VOLUME REPRESENTATIONS

(71) Applicants: Adobe Inc., San Jose, CA (US); THE REGENTS OF THE UNIVERSITY OF CALIFORNIA, Oakland, CA (US)

(72) Inventors: Kai Zhang, San Jose, CA (US); Zexiang Xu, San Jose, CA (US); Xinyue Wei, La Jolla, CA (US); Valentin Mathieu Deschaintre, London (GB); Sai Bi, San Jose, CA (US); Kalyan Krishna Sunkavalli, San Jose, CA (US); Hao Tan, San Jose, CA (US); Fujun Luan, Sunnyvale, CA (US); Hao Su, San Diego, CA (US)

(73) Assignees: Adobe Inc., San Jose, CA (US); THE REGENTS OF THE UNIVERSITY OF CALIFORNIA, Oakland, CA (US)

(21) Appl. No.: 18/797,670

(22) Filed: Aug. 8, 2024

(51) Int. Cl. G06T 17/20; G06T 15/06; G06T 15/08

(52) U.S. Cl. CPC G06T 17/20; G06T 15/06; G06T 15/08; G06T 2200/24

(57) ABSTRACT

In implementation of techniques for generating meshes by decoding volume representations, a computing device implements a mesh generation system to receive digital images depicting an object from different angles. The mesh generation system generates a volume representation of the object using a transformer model based on the digital images. By decoding information from the volume representation using an algorithm, the mesh generation system then generates a mesh of the object from the volume representation. The mesh generation system then presents the mesh of the object in a user interface.

### BACKGROUND

A mesh is a collection of nodes, edges, and faces that define a geometry of a three-dimensional object. Meshes are used to represent and render three-dimensional objects for various applications, including video games, virtual reality, alternate reality, computer-aided design, and animation. By combining nodes, edges, and faces, the mesh represents complex surfaces of the three-dimensional object. For example, connections between the nodes and the arrangement of faces define shapes of surfaces and an overall structure of the mesh. However, mesh generation techniques use a significant amount of data to render meshes, which causes errors and results in visual inaccuracies, computational inefficiencies, and increased power consumption in real world scenarios.

### SUMMARY

Techniques and systems for generating meshes by decoding volume representations are described. In an example, a mesh generation system receives digital images depicting an object from different angles.

The mesh generation system generates a volume representation of the object using a transformer model based on the digital images. The volume representation is a triplane Neural Radiance Field (NeRF), and the transformer model is trained using ray-marching based field rendering, for example. Some examples further comprise generating image tokens for input to the transformer model by patchifying and linearizing the digital images and initializing triplane tokens for input to the transformer model with the image tokens. In some examples, the transformer model is trained using differentiable marching cubes and differentiable rasterization.

Using an algorithm, the mesh generation system decodes information from the volume representation and generates a mesh of the object from the volume representation. In some implementations, the algorithm decodes density information from the volume representation. In some examples, the triplane tokens are unpatchified by the algorithm for generating the volume representation. The mesh generation system then presents the mesh of the object in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for generating meshes by decoding volume representations as described herein.

FIG. 2 depicts a system in an example implementation showing operation of a mesh progression module for generating meshes by decoding volume representations.

FIG. 3 depicts an example of an architecture of a mesh generation module for generating meshes by decoding volume representations.

FIG. 4 depicts an example of training a transformer model using ray-marching based field rendering.

FIG. 5 depicts an example of a mesh rasterizer for generating a mesh.

FIG. 6 depicts an example of an output including the mesh.

FIG. 7 depicts a procedure in an example implementation of generating meshes by decoding volume representations.

FIG. 8 depicts a procedure in an additional example implementation of generating meshes by decoding volume representations.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

A mesh is a three-dimensional representation formed by nodes, edges, and faces that define a shape and a structure of an object. The nodes are individual points in three-dimensional space that define positions of the object's corners, edges, and surface points. The mesh, for instance, is rendered in a virtual environment to represent the object. Meshes are usable for creating realistic virtual objects for virtual reality or alternate reality, and have applications in video games, animations, e-commerce, and other disciplines.

Meshes are typically created manually by professional artists, which is time-consuming and involves a high level of expertise in graphic design. Conventional mesh generation techniques attempt to simplify mesh generation by forming meshes based on an object depicted in two-dimensional images, instead of generating a mesh from scratch. These conventional mesh generation techniques output a volume representation of the object, which is directly edited into a mesh by adding color or other features in post-processing. However, these meshes are inaccurate because the volume representation that is the basis of the mesh generally includes unwanted artifacts, including three-dimensional portions that are absent from the object depicted in the two-dimensional images. For instance, artifacts called “floaters” have no density but are mistakenly incorporated into the volume representation, resulting in meshes that are not aesthetically-pleasing because they do not accurately represent the object and appear unnatural.

Techniques and systems are described for generating meshes by decoding volume representations that overcome these limitations. For instance, a transformer model generates a volume representation of an object depicted in digital images. Unlike the conventional mesh generation techniques, however, a mesh rasterizer algorithm generates a mesh of the object from the volume representation by decoding density information from the volume representation. The density information is leveraged to generate a more accurate mesh than directly using the volumetric information. For instance, generating the mesh based on density information reduces the “floater” artifacts that have zero density in the mesh and result from generating the mesh directly from the volumetric information, as in the conventional mesh generation techniques.

A mesh generation system begins in this example by receiving an input including digital images that depict an object from different angles. For example, the object is a dog, and a first digital image depicts the dog from a front angle, a second digital image depicts the dog from a side angle, and a third digital image depicts the dog from a rear angle.

The mesh generation system uses a transformer model to generate a triplane Neural Radiance Field (NeRF) based on the digital images. The triplane NeRF is a type of volume representation that captures both geometry and appearance, including texture and lighting, of the object in three (x, y, z) planes. The transformer model is trained to predict the triplane NeRF from the digital images using ray-marching based field rendering, which evaluates rays cast from a camera into a scene. For instance, the transformer model generates the triplane NeRF by evaluating lighting, shadows, and other visual effects depicted in the scene of the digital images, encoding density information related to the object into the triplane NeRF.

The mesh generation system then uses a mesh rasterizer or other algorithm to extract density information from the triplane NeRF. The algorithm is trained to refine mesh surface extractions by performing differentiable marching cubes on a predicted density field based on the triplane NeRF and minimize a surface rendering loss with differentiable rasterization. Leveraging differentiable marching cubes, for instance, decodes the density information from the triplane NeRF.

Based on the density information, the mesh generation system generates an output including a mesh for rendering in the user interface. The mesh in this example is a three-dimensional representation of the dog depicted in the digital images. Because the mesh generation system generates the mesh based on the density information, the mesh generation system excludes artifacts from the mesh that have densities below a threshold density (e.g., zero), preventing “floater” artifacts from incorporation into the mesh.

Generating meshes by decoding volume representations in this manner overcomes the disadvantages of conventional mesh generation techniques that are limited to generating a mesh by directly editing a volume representation. For example, generating the mesh of the object from the triplane NeRF by decoding density information from the triplane NeRF results in a more accurate mesh than directly using the volumetric information. Additionally, because the mesh is generated without post processing, mesh generation time is reduced. For these reasons, generating meshes by decoding volume representations is more accurate and efficient than conventional mesh generation techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

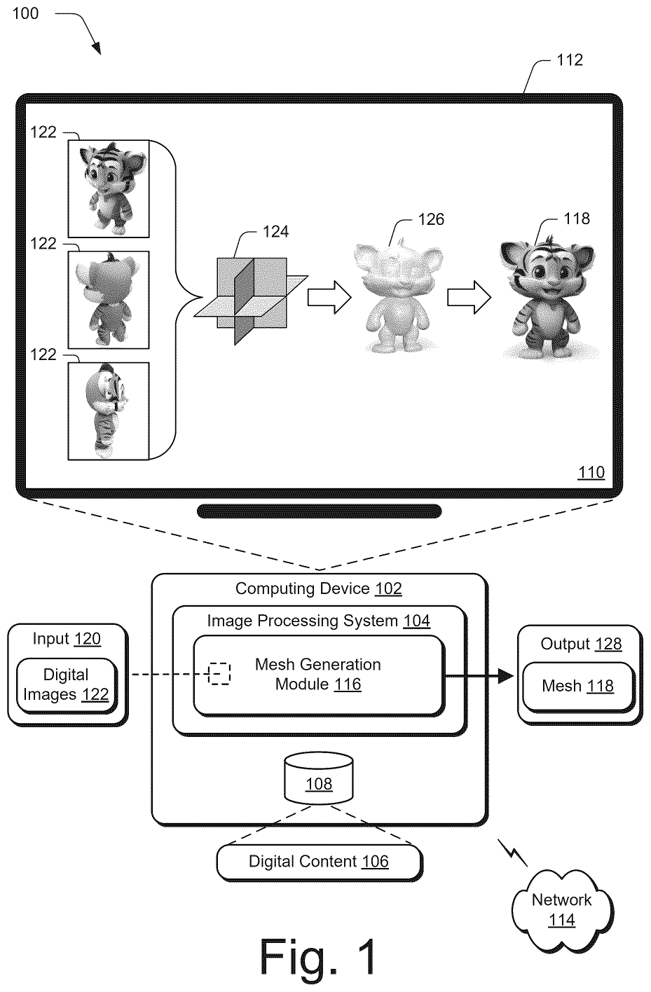

FIG. 1 is an illustration of a digital medium environment 100 in an example implementation that is operable to employ techniques and systems for generating meshes by decoding volume representations described herein. The illustrated digital medium environment 100 includes a computing device 102, which is configurable in a variety of ways.

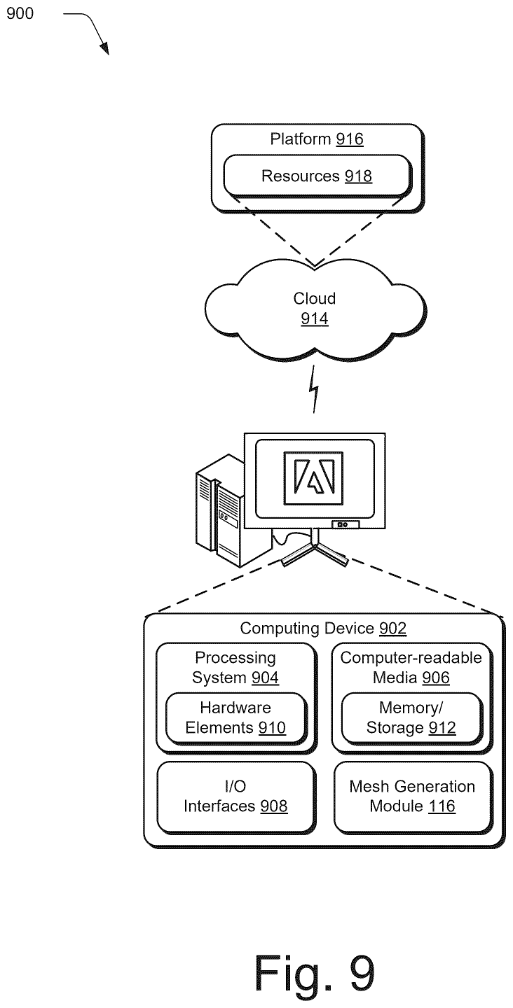

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 9.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a mesh generation module 116 which is illustrated as incorporated by the image processing system 104 to process the digital content 106. In some examples, the mesh generation module 116 is separate from the image processing system 104 such as in an example in which the mesh generation module 116 is available via the network 114.

The mesh generation module 116 is configured to generate a mesh 118, which is a virtual, three-dimensional representation of an object. For example, the mesh generation module 116 first receives an input 120 including digital images 122. The digital images 122 depict different angles of the object, which is an animated tiger in this example. For instance, the digital images 122 are captured by an image capture device of a real-life object or are scenes created by a generative machine learning model.

After receiving the digital images 122, the mesh generation module 116 generates a triplane Neural Radiance Field (NeRF) 124 based on the digital images 122 using a transformer model. The triplane NeRF 124 is a volume representation of the object that encodes three-dimensional information in three orthogonal planes (e.g., XY, XZ, and YZ planes). The transformer model in this example is trained using ray-marching based field rendering, which samples rays cast through the scene depicting the object in the digital images 122. For instance, the transformer model receives as input image tokens and triplane tokens representing visual features of the digital images 122 that are patchified and linearized, and the transformer model transforms the triplane tokens based on the image tokens. The triplane NeRF 124 includes encoded information including density information 126 and color information.

The mesh generation module 116 uses an algorithm, including a mesh rasterizer, to decode the density information 126 from the triplane NeRF 124. The algorithm, for instance, is a mesh rasterizer that uses differentiable marching cubes and differentiable rasterization to generate a mesh 118. The differentiable marching cubes, for instance, is a technique involving rendering a polygonal mesh of an isosurface from a three-dimensional scalar field of the triplane NeRF 124.

Based on the density information 126, the mesh generation module 116 generates an output 128 including the mesh 118 for display in the user interface 110. In this example, the mesh 118 is a three-dimensional representation of the tiger depicted in the digital images 122. Because the mesh 118 represents exterior surfaces of the tiger, the mesh 118 is configurable for rotation or editing in a virtual three-dimensional environment.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generating Meshes by Decoding Volume Representations

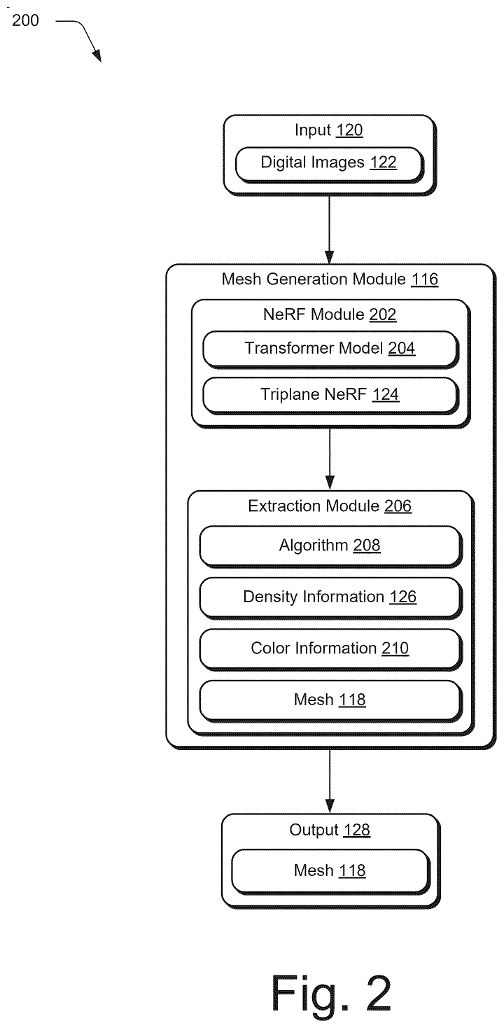

FIG. 2 depicts a system 200 in an example implementation showing operation of the mesh generation module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-9.

To begin in this example, a mesh generation module 116 receives an input 120 including digital images 122. The digital images 122 depict an object from different angles. For example, a first digital image depicts the object from a first angle, a second digital image depicts the object from a second angle, and a third digital image depicts the object from a third angle. In this example, the digital images 122 are sparse in number, which for example is three to five digital images. However, in some examples the input 120 includes fewer or more digital images. Further, the digital images 122 are still, two-dimensional images captured from an image capture device. In other examples, however, the input 120 includes three-dimensional images, renderings, or frames from digital video depicting the object.

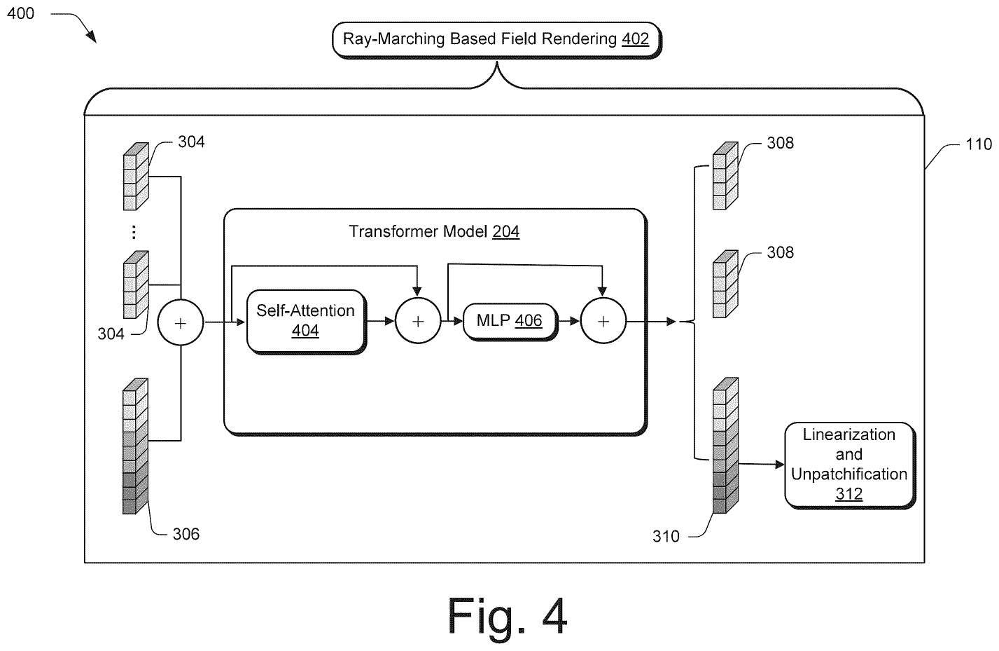

The mesh generation module 116 includes a NeRF module 202. The NeRF module 202 uses a transformer model 204 to generate a triplane NeRF 124 based on the digital images 122. The transformer model 204 is trained to predict the triplane NeRF 124 from the digital images 122 by supervising volume renderings at novel views. For instance, the transformer model 204 is trained using ray-marching based field rendering, which is explained in further detail with respect to FIG. 4.

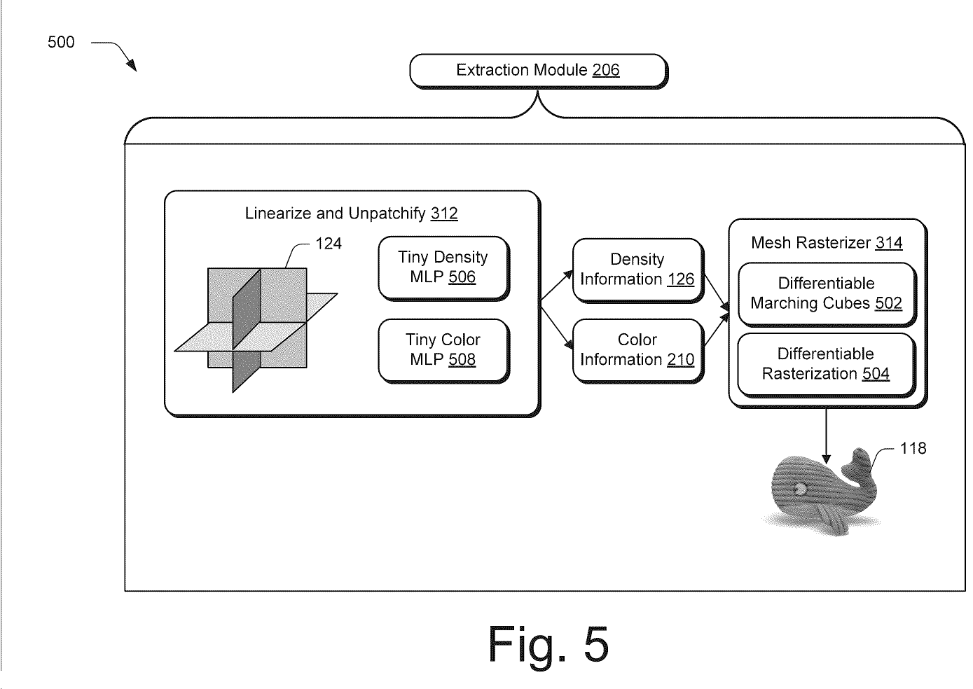

The mesh generation module 116 also includes an extraction module 206. The extraction module 206 uses an algorithm 208, an example of which is a mesh rasterizer, to extract density information 126 and color information 210 in some examples from the triplane NeRF 124. The algorithm 208 is trained to refine mesh surface extractions by performing differentiable marching cubes on the predicted density field and minimizing a surface rendering loss with differentiable rasterization, which is explained in further detail with respect to FIG. 5.

Based on the density information 126, the mesh generation module 116 generates an output 128 including a mesh 118 for rendering in the user interface 110. The mesh 118, for instance, is a three-dimensional representation of the object depicted in the digital images 122. Because the mesh generation module 116 generates the mesh 118 based on the density information 126, the mesh generation module 116 excludes artifacts from the mesh 118 that have densities below a threshold density (e.g., zero), preventing “floater” artifacts from incorporation into the mesh 118.

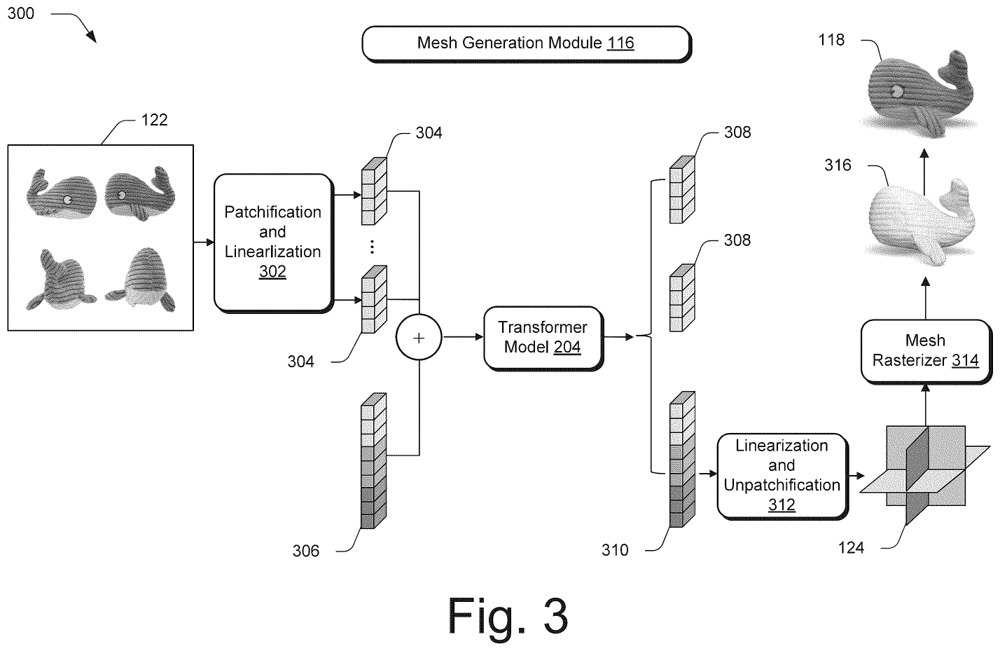

FIGS. 3-6 depict stages of generating meshes by decoding volume representations. In some examples, the stages depicted in these figures are performed in a different order than described below.

FIG. 3 depicts an example 300 of an architecture of a mesh generation module for generating meshes by decoding volume representations. The mesh generation module includes a sequence of self-attention-based transformer blocks over concatenated image tokens and triplane tokens.

As illustrated, a mesh generation module 116 receives digital images 122 as input, which depict surfaces of a whale in this example. Patchification and linearlization 302 is performed on the digital images 122 using a tokenizer, outputting image tokens 304. The patchification involves dividing an image or group of data into smaller, fixed-size patches or groups. The linearization involves transforming a complex, linear function or model into a simpler, linear form. The tokenizer converts camera parameters for each image into Plucker ray coordinates and concatenates the camera parameters with red, green, and blue (RGB) pixels to form triplane tokens 306, which collectively form a 9-channel feature map. Plucker ray coordinates, for instance, are a way of representing lines in three-dimensional space using six homogeneous coordinates.

The triplane tokens 306, for instance, represent three-dimensional information by projecting it onto three orthogonal two-dimensional planes. In a triplane representation, three two-dimensional planes are aligned with principal axes (XY, YZ, and ZX planes), which capture spatial information from different perspectives. The XY plane captures the spatial layout in the horizontal plane. The YZ plane captures the spatial layout in the vertical plane (side view). The ZX plane captures the spatial layout in the horizontal plane from another angle. During tokenization, the data on the XY, YZ, and ZX planes is divided into tokens, which are smaller patches or segments that the neural network processes individually. The triplane tokens 306 contain local information about the three-dimensional structure projected onto that plane. The triplane tokens 306 are then split into non-overlapping patches, and linearly transformed as input to the transformer model 204. Because the Plucker coordinates contain spatial information in this example, the model does not involve additional positional embedding. Unlike conventional mesh generation techniques, the architecture of the mesh generation module 116 does not involve a per-view DINO encoding, enabling a more efficient flow between raw pixels from the digital images 122 and the three-dimensional information.

The transformer model 204 concatenates multi-view image tokens and learnable triplane positional embeddings, which are fed into a sequence of transformer blocks that include self-attention and multilayer perceptron (MLP) layers, outputting output image tokens 308 and output triplane tokens 310. The output image tokens 308 are dropped at this stage. In some examples, normalization is included in the architecture, which involves adjusting values of input features so that they exist on a common scale. The transformer model 204 enables information exchange among the tokens, modeling intra-view, inter-view, and cross-modal relationships. The output triplane tokens, conceptualized by the input views, are decoded, including linearization and unpatchification 312, into a triplane NeRF 124. Unpatchificaiton involves reconstructing an image from its smaller patches or segments, reversing the process of patchification. The output triplane tokens 310 are unprojected with a linear layer and further unpatchified to 8×8 triplane features via reshaping. The predicted triplane features are then assembled into the triplane NeRF 124.

In this example, the architecture of the mesh generation module 116 includes tiny MLPs with narrower hidden dimensions of 32 and fewer layers than conventional mesh generation techniques. In this example, an MLP with one hidden layer is used for density decoding, and an additional MLP with two hidden layers is used for color decoding. For example, the density MLP and the color MLP are used separately in the marching cubes and rendering.

Because the transformer model 204 effectively transforms the digital images 122 into a triplane NeRF 124 that includes encoded density information, a mesh rasterizer 314 decodes density information 316 and color information from the triplane NeRF 124. This achieves both radiance field rendering for a first stage volume initialization and surface extraction and rendering for a second stage mesh reconstruction.

Based on the density information 316, the mesh generation module 116 generates an output 128 including a mesh 118 for display in the user interface 110. In some examples, the transformer model 204 interpolates vertex values, including density, across faces of the mesh 118, resulting in smooth transitions and variations across surfaces of the mesh 118. During rasterization, the interpolated density values are passed to the fragment shader, which computes a final color of the pixels based on the interpolated attributes. The density value is interpolated as opacity in the fragment shader. Higher density values correspond to more opaque regions, while lower values correspond to more transparent regions. In some examples, alpha blending is used to combine the colors or overlapping fragments based on opacity. Alpha blending, for instance, combines a foreground image with a background image to create the appearance of partial or full transparency.

In this example, the mesh 118 is a three-dimensional representation of the whale depicted in the digital images 122. Generating the mesh 118 of the whale from the triplane NeRF 124 by decoding density information 316 from the triplane NeRF 124 results in a more accurate mesh than directly using the volumetric information performed by conventional mesh generation techniques. Additionally, because the mesh 118 is generated without post processing, mesh generation time is reduced.

FIG. 4 depicts an example 400 of training a transformer model using ray-marching based field rendering. FIG. 4 is a continuation of the example described in FIG. 3.

In this example, the transformer model 204 is trained with ray marching-based radiance field rendering 402. Instead of training directly using high-resolution (512×512 pixel) input images by conventional mesh generation techniques, the transformer model 204 is trained with 256×256 pixel images until convergence and then fine-tuned with fewer iterations of 512×512 pixel images. This reduces training time compared to the conventional mesh generation techniques. In other examples, however, the transformer model 204 is trained with different images or resolutions.

The transformer model 204 is pretrained using 256-pixel resolution images for both input and output. A batch size of 8 objects per GPU and sample of 128 points per ray during ray marching is used. For instance, efficiency of training is increased from the low-resolution pre-training from two factors: shorter sequence length for computing self-attention 404 and fewer samples per ray for volume rendering, compared to high-resolution fine-tuning. In this example, the transformer model 204 includes an MLP 406 that receives input from the self-attention 404 layer to output the output image tokens 308 and the output triplane tokens 310.

In some examples, the transformer model 204 is trained using differentiable marching cubes and differentiable rasterization to prevent artifact creation when the mesh 118 is generated using the algorithm 208, as described in further detail with respect to FIG. 5. Differentiable marching cubes, for instance, involves extracting density information 126 from the triplane NeRF 124, resulting in computed gradients for input volumetric data, enabling shape optimization, physics-based simulations, and neural rendering.

For high-resolution fine-tuning, 512-pixel resolution images are used for input and output. A batch size of 2 per GPU, 512 points per ray are densely sampled. Increased computation costs are compensated for by reducing the batch size 4 times, for example, achieving a training speed of the low-resolution training.

For loss, an L2 regression loss L_{v,r} and a perceptual loss L_{v,p} is used to supervise the renderings from both phases. Because rendering full-resolution images is not affordable for volume rendering, a 128×128 pixel patch is randomly sampled from each target for 256 or 512 pixel resolution image for supervision with both losses. 4096 pixels are randomly sampled per target image for additional L2 supervision, allowing the transformer model 204 to capture global information beyond a single patch. The loss for volume rendering training is expressed by:

$${L}_{v} = {L}_{v , r} + {w}_{v , p} * {L}_{v , p}$$

where w_{v,p}=0.5 for both 256-pixel and 512-pixel resolution training.

FIG. 5 depicts an example 500 of a mesh rasterizer for generating a mesh. FIG. 5 is a continuation of the example described in FIG. 4. After the transformer model 204 is trained with ray-marching field based rendering 402 for generating a triplane NeRF 124, the mesh rasterizer 314 generates a mesh 118.

In this example, the extraction module 206 includes a mesh rasterizer 314 that is fine-tuned with differentiable marching cubes 502 and differentiable rasterization 504, enabling high-quality feed-forward mesh reconstruction. Differentiable marching cubes 502, unlike traditional marching cubes that generate polygonal meshes from volumetric data, introduces differentiability while extracting density information 126 from the triplane NeRF 124. This differentiability allows gradients to be computed with respect to the input volumetric data, enabling shape optimization, physics-based simulations, and neural rendering. By embedding the marching cubes procedure within a differentiable framework, the differentiable marching cubes 502 facilitates the integration of mesh generation into larger neural network architectures, making it possible to optimize shapes directly from data gradients and to refine generated meshes based on loss functions.

In this example, a 256³ density grid is constructed by decoding the triplane features of the triplane NeRF 124, and the differentiable marching cubes 502 is adopted to extract mesh surfaces from the grid. The differentiable marching cubes 502 is based on a highly optimized CUDA implementation, enabling fast training and inference for mesh reconstruction. The differentiable marching cubes 502 is an extension of a marching cubes algorithm, which extracts a polygonal mesh from a scalar field. Using differentiable marching cubes 502 enables computation of gradients of the generated mesh with respect to the input scalar field, enabling its integration into end-to-end trainable systems, including the mesh generation module 116. In some examples, the differentiable marching cubes 502 outputs the mesh 118 in addition to gradients (Jacobian matrix) relating to changes in the input field to changes in the mesh, enabling backpropagation.

Differentiable rasterization 504 involves computation of gradients through the rasterization by converting vector graphics for three-dimensional models into a raster image of pixels. Because the rasterization is differentiable, it is capable of being integrated into gradient-based optimization frameworks enabling optimization of graphics and vision tasks through backpropagation.

The extraction module 206 also includes a tiny density MLP 506 for decoding density information 126 and a tiny color MLP 508 for decoding color information 210. The tiny density MLP 506 is an architecture designed to model density functions or distributions and used to learn mappings between inputs and outputs by passing information through multiple layers of interconnected neurons. For example the MLP 506 and the tiny color MLP 508 minimize parameters using techniques including weight pruning, quantization, or using low-rank approximations.

To compute the rendering loss, a mesh is rendered. For instance, using a differentiable rasterizer, triplane features are neurally rendered into novel images from extracted meshes. This full rendering process involves obtaining per-pixel XYZ locations via differentiable rasterization 504 before querying the corresponding triplane features of the triplane NeRF 124 and regressing per-pixel colors using the tiny color MLP 508. Novel view renderings are supervised with ground-truth images, optimizing the model for high-quality end-to-end mesh reconstruction, for example, to generate images of the scene from viewpoints that were not observed during training.

To stabilize the training and prevent the formation of floaters, a ray opacity loss is used. The ray opacity loss is a metric used in differentiable rendering frameworks to optimize the transparency or opacity of objects within a scene. This loss function calculates the discrepancy between the rendered image and a target image based on how light interacts with transparent or translucent materials along rays cast from a virtual camera. By comparing the accumulated opacity along each ray in the rendered image to that in the target image, the loss quantifies the difference in transparency perception. This loss is applied to each rendered pixel ray, expressed by:

$${L}_{α} = {‖ {α}_{q} ‖}_{1} , {α}_{q} = 1 - exp ( - {σ}_{q} ‖ p - q ‖ )$$

where p represents the ground truth surface point along the pixel ray, q is randomly sampled along the ray between p and camera origin, and σ_{q} is the volume density at q; when no surface exists for a pixel, q is sampled inside the object bounding box along the ray and the far ray-box intersection is used as p.

The loss enforces the empty space in each view frustum to contain near-zero density. The opacity value α_{q}, computed using the ray distance from the sampled point to the surface, is minimized. This density-to-opacity conversion functions as for weighting the density supervision along the ray with lower loss values for points sampled closer to the surface. The ray opacity loss enables the training of neural networks to accurately model and reproduce complex optical effects, including refraction and light transmission through semi-transparent surfaces, enhancing the quality of the mesh 118.

To measure the visual difference between the renderings and the ground-truth (GT) images, an L2 loss L_{m,r} and a perceptual loss L_{m,p} are used. To compute the ray opacity loss L_{α}, surface points are obtained using the GT depth maps. In addition, to further improve the geometry accuracy and smoothness, an L 2 normal loss Lₙ is applied to supervise the face normals of the extracted mesh with GT normal maps in foreground regions. The final loss for mesh reconstruction is:

$${L}_{m} = {L}_{m , r} + {w}_{m , p} * {L}_{m , p} + {w}_{α} * {L}_{α} + {w}_{n} * {L}_{n}$$

where w_{m,p}=2, w_{α}=0.5 and wₙ=1 in this example. Because mesh rasterization is cheaper than volume ray marching, the images are rendered at full resolution (e.g., 512×512 pixels in this example) for supervision, instead of the random patches and rays.

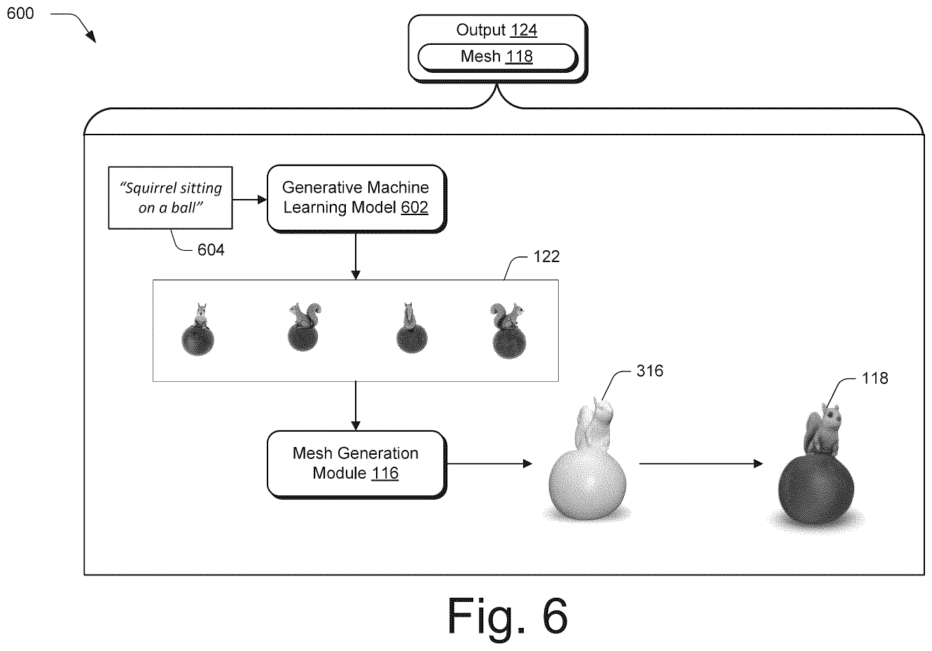

FIG. 6 depicts an example 600 of an output including a mesh. FIG. 6 is a continuation of the example described in FIG. 3.

As illustrated, the mesh generation module 116 in this example receives digital images 122 generated by a generative machine learning model 602. For instance, given a prompt 604 “Squirrel sitting on a ball,” the generative machine learning model 602 generates the digital images 122, which include a front view, two side views, and a rear view of a squirrel sitting on a ball. For instance, in this example the subject of the digital images 122 is an object that does not exist in real-life.

For instance, the generative machine learning model 602 is a text-to-image generative model that creates visual content from the prompt 604, including textual descriptions, by leveraging deep learning techniques including generative adversarial networks (GANs) or variational autoencoders (VAEs). To begin, the generative machine learning model 602 transforms the prompt 604 including the FIG. 1 textual description into a fixed-length vector representation capturing the semantic meaning of the text. This encoded vector is then fed into a generator network of the generative machine learning model 602 that produces images conditioned on the text features. In some examples, the generator network includes layers that progressively upscale the feature maps to form a high-resolution image. Simultaneously, a discriminator network of the generative machine learning model 602 evaluates the generated images against real images, providing feedback to the generator to improve the quality and relevance of the outputs through adversarial training. In some examples, additional conditioning techniques, including attention mechanisms, are used to enhance the correlation between specific words in the text and corresponding regions in the image.

The mesh generation module 116 then generates a mesh 118 of the squirrel sitting on the ball. For instance, the mesh generation module 116 includes a NeRF module 202. The NeRF module 202 uses a transformer model 204 to generate a triplane NeRF 124 based on the digital images 122. The transformer model 204 is trained to predict the triplane NeRF 124 from the digital images 122 by supervising volume renderings at novel views. For instance, the transformer model 204 is trained using ray-marching based field rendering.

The mesh generation module 116 also includes an extraction module 206. The extraction module 206 uses an algorithm 208, an example of which is a mesh rasterizer, to extract density information 316 and color information in some examples from the triplane NeRF 124. The algorithm 208 is trained to refine mesh surface extractions by performing differentiable marching cubes 502 on the predicted density field and minimizing a surface rendering loss with differentiable rasterization 504.

Based on the density information 126, the mesh generation module 116 generates an output 128 including a mesh 118 for rendering in the user interface 110. The mesh 118, for instance, is a three-dimensional representation of the object depicted in the digital images 122. Because the mesh generation module 116 generates the mesh 118 based on the density information 126, the mesh generation module 116 excludes artifacts from the mesh 118 that have densities below a threshold density (e.g., zero), preventing “floater” artifacts from incorporation into the mesh 118. This results in a more accurate mesh than directly using the volumetric information performed by conventional mesh generation techniques. Additionally, because the mesh 118 is generated without post processing, mesh generation time is reduced.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-9.

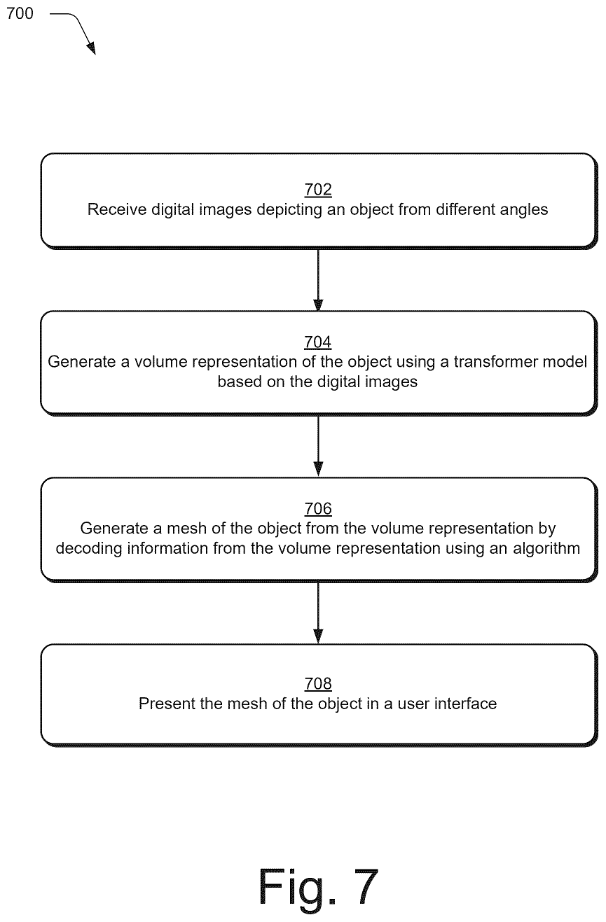

FIG. 7 depicts a procedure 700 in an example implementation of generating meshes by decoding volume representations. At block 702, digital images 122 depicting an object from different angles are received.

At block 704, a volume representation of the object is generated using a transformer model 204 based on the digital images 122. For example, the volume representation is a triplane Neural Radiance Field (NeRF) 124. In some examples, the transformer model 204 is trained using ray-marching based field rendering 402. Some examples further comprise generating image tokens 304 for input to the transformer model 204 by patchifying and linearizing the digital images 122. Additionally, some examples further comprise initializing triplane tokens 306 for input to the transformer model 204 with the image tokens 304. For example, the transformer model 204 outputs triplane tokens 306 that are informed by the different angles of the digital images 122. In some examples, the transformer model 204 is trained using differentiable marching cubes and differentiable rasterization.

At block 706, a mesh 118 of the object is generated from the volume representation by decoding information from the volume representation using an algorithm 208. In some examples, the algorithm 208 decodes density information 126 from the volume representation. In some examples, the triplane tokens 306 are unpatchified by the algorithm 208 for generating the volume representation.

At block 708, the mesh 118 of the object is presented in a user interface 110. For example, the mesh 118 is a three-dimensional representation of surfaces of the object depicted in the digital images 122. In some examples, the mesh is a polygon mesh.

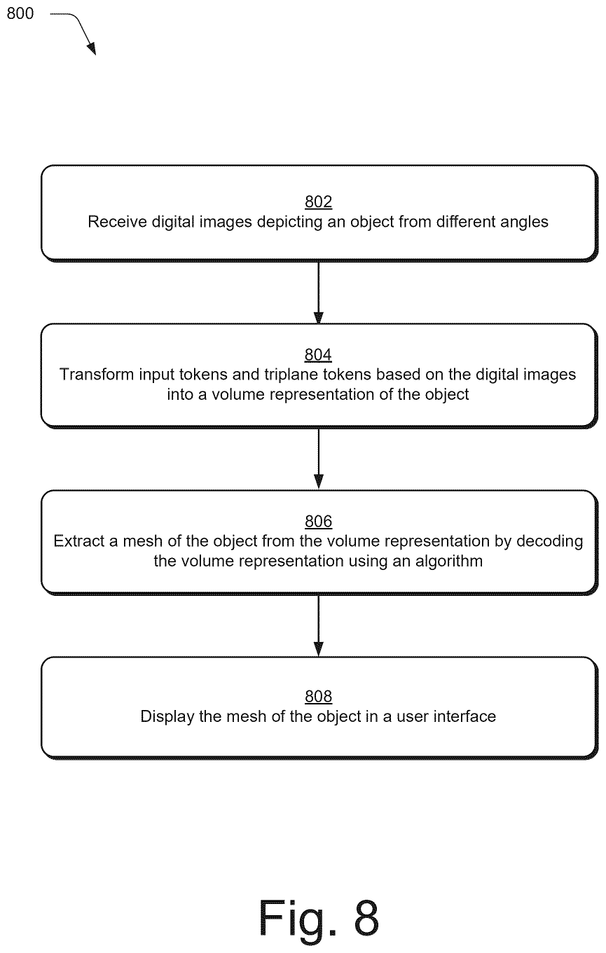

FIG. 8 depicts a procedure 800 in an additional example implementation of generating meshes by decoding volume representations. At block 802, digital images 122 depicting an object from different angles are received.

At block 804, input tokens and triplane tokens 306 are transformed based on the digital images 122 into a volume representation of the object. In some examples, the volume representation is a triplane Neural Radiance Field (NeRF) 124. For example, the transforming the input tokens and the triplane tokens 306 is performed by a transformer model 204 trained using ray-marching based field rendering 402. In some examples, the input tokens are image tokens 304 that are generated by patchifying and linearizing the digital images 122. Additionally or alternatively, in some examples, the transformer model 204 is trained using differentiable marching cubes and differentiable rasterization.

At block 806, a mesh 118 of the object is extracted from the volume representation by decoding the volume representation using an algorithm 208. For example, the algorithm 208 decodes density information 126 from the volume representation. Additionally or alternatively, the triplane tokens 306 are unpatchified by the algorithm 208 for generating the volume representation.

At block 808, the mesh 118 of the object is displayed in a user interface 110. For instance, the mesh 118 is a three-dimensional construction that represents surfaces of the object in a virtual environment. Additionally or alternatively, color information extracted from the triplane NeRF 124 is incorporated onto the mesh 118.

### Example System and Device

FIG. 9 illustrates an example system generally at 900 that includes an example computing device 902 that is representative of one or more computing systems and/or devices that implement the various techniques described herein. This is illustrated through inclusion of the mesh generation module 116. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 1114 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized when computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method comprising:
receiving, by a processing device, digital images depicting an object from different angles;
generating, by the processing device, a volume representation of the object using a transformer model based on the digital images;
generating, by the processing device, a mesh of the object from the volume representation by decoding information from the volume representation using an algorithm; and
presenting, by the processing device, the mesh of the object in a user interface.

2. The method of claim 1, wherein the volume representation is a triplane Neural Radiance Field (NeRF).

3. The method of claim 1, wherein the algorithm decodes density information from the volume representation.

4. The method of claim 1, wherein the transformer model is trained using ray-marching based field rendering.

5. The method of claim 1, wherein the transformer model is trained using differentiable marching cubes and differentiable rasterization.

6. The method of claim 1, further comprising generating image tokens for input to the transformer model by patchifying and linearizing the digital images.

7. The method of claim 6, further comprising initializing triplane tokens for input to the transformer model with the image tokens.

8. The method of claim 7, wherein the triplane tokens are unpatchified by the algorithm for generating the volume representation.

9. The method of claim 1, wherein the transformer model outputs triplane tokens that are informed by the different angles of the digital images.

10. A system comprising:
a memory component; and
a processing device coupled to the memory component, the processing device to perform operations comprising:
receiving digital images depicting an object from different angles;
transforming input tokens and triplane tokens based on the digital images into a volume representation of the object;
extracting a mesh of the object from the volume representation by decoding the volume representation using an algorithm; and
displaying the mesh of the object in a user interface.

11. The system of claim 10, wherein the volume representation is a triplane Neural Radiance Field (NeRF).

12. The system of claim 10, wherein the algorithm decodes density information from the volume representation.

13. The system of claim 10, wherein the transforming the input tokens and the triplane tokens is performed by a transformer model trained using ray-marching based field rendering.

14. The system of claim 10, wherein the transformer model is trained using differentiable marching cubes and differentiable rasterization.

15. The system of claim 10, wherein the input tokens are image tokens that are generated by patchifying and linearizing the digital images.

16. The system of claim 10, wherein the triplane tokens are unpatchified by the algorithm for generating the volume representation.

17. A non-transitory computer-readable storage medium storing executable instructions, which when executed by a processing device, cause the processing device to perform operations comprising:
receiving digital images depicting an object from different angles;
generating a volume representation of the object using a transformer model based on the digital images;
extracting a mesh of the object from the volume representation by decoding the volume representation using an algorithm; and
displaying the mesh of the object in a user interface.

18. The non-transitory computer-readable storage medium of claim 17, wherein the volume representation is a triplane Neural Radiance Field (NeRF).

19. The non-transitory computer-readable storage medium of claim 17, wherein the transformer model is trained using differentiable marching cubes and differentiable rasterization.

20. The non-transitory computer-readable storage medium of claim 17, wherein the transformer model is trained using ray-marching based field rendering.
